(19) United States
(12) Patent Application Publication
(10) Pub. No.: US 2021/0325898 A1
(43) Pub. Date: Oct. 21, 2021

(54) USING DRONE DATA TO GENERATE HIGH-DEFINITION MAP FOR AUTONOMOUS VEHICLE NAVIGATION

(71) Applicant: Micron Technology, Inc., Boise, ID (US)

(72) Inventor: Gil Golov, Backnang (DE)

(21) Appl. No.: 16/854,658

(22) Filed: Apr. 21, 2020

(51) Int. Cl. G05D 1/02; G05D 1/00; B64C 39/02; G06N 20/00

(52) U.S. Cl. CPC G05D 1/0276; G05D 1/0088; G05D 1/0274; G05D 2201/0213; G06N 20/00; B64C 2201/123; B64C 2201/208; B64C 39/024

(57) ABSTRACT

An autonomous vehicle navigates using a digital map stored in memory. In one approach, the vehicle plans a navigation route that includes a geographic location (e.g., a location on a road to be traveled by the vehicle). An unmanned aerial vehicle (UAV) collects sensor data at the geographic location (e.g., in advance of travel on the road). The collected sensor data is processed to generate map data for objects or other features at the geographic location. The digital map is updated using the generated map data.

### FIELD OF THE TECHNOLOGY

At least some embodiments disclosed herein relate to digital maps in general, and more particularly, but not limited to generating data for a digital map using data collected by an unmanned aerial vehicle (UAV).

### BACKGROUND

Autonomous vehicles typically navigate by using digital maps. One example of such digital map is a high-definition map (HDMAP). In one example, a high-definition map permits an autonomous vehicle to safely navigate a road. The road typically includes landmarks such as traffic signs, etc. To build a landmark map portion of a high-definition map, a system needs to determine the location and type for various landmarks (e.g., objects along a road on which vehicles must navigate).

In one approach, a system uses image-based classification to determine the types of landmarks. The system also further determines the location and orientation of each landmark with respect to the map coordinates. Precise coordinates of landmarks allow the autonomous vehicle to accurately predict where an object will be located using the vehicle sensor data so that the vehicle can validate the map's prediction of the environment, detect changes to the environment, and locate the position of the vehicle with respect to the map.

Autonomous vehicles drive from a source location to a destination location without requiring human drivers to control or navigate the vehicle. Autonomous vehicles use sensors to make driving decisions in real-time, but the sensors are not able to detect all obstacles and problems that will be faced by the vehicle. For example, road signs or lane markings may not be readily visible to sensors.

Autonomous vehicles can use map data to determine some of the above information instead of relying on sensor data. However, existing maps often do not provide a high level of accuracy required for safe navigation. Also, many maps are created by survey teams that use drivers with specially-equipped cars having sensors that drive around a geographic region and take measurements. This process is expensive and time-consuming. Also, maps made using such techniques do not have up-to-date information. As a result, conventional techniques of maintaining maps do not provide data that is sufficiently accurate and up-to-date for safe navigation by autonomous vehicles.

### BRIEF DESCRIPTION OF THE DRAWINGS

The embodiments are illustrated by way of example and not limitation in the figures of the accompanying drawings in which like references indicate similar elements.

FIG. 1 shows a map server that generates map data based on sensor data collected by an unmanned aerial vehicle, in accordance with some embodiments.

FIG. 2 shows an autonomous vehicle that stores a digital map based in part on data collected by an unmanned aerial vehicle, in accordance with some embodiments.

FIG. 3 shows a method for updating a digital map based on sensor data collected by an unmanned aerial vehicle, in accordance with some embodiments.

### DETAILED DESCRIPTION

The following disclosure describes various embodiments for generating new data for a digital map based on data collected by an unmanned aerial vehicle (UAV). At least some embodiments herein relate to digital maps used by autonomous vehicles (e.g., self-driving cars, planes, boats). In one example, a first UAV collects data used to update a map used by a ground-based vehicle to navigate a road. A second UAV can be used to collect further data for the map from the same geographic location, an adjacent location, or a different location.

In one example, a high-definition map (HD map) contains detailed three-dimensional models of roads and the surrounding environment. In one example, the map contains data regarding objects such as road edges, road dividers, curbs, shoulders, traffic signs, traffic signals, poles, fire hydrants, and other features of roads and structures. This level of detail is typically not adequately obtainable using traditional satellite or aerial imagery alone. Instead, fleets of ground-based vehicles are used to collect data for HD maps.

Thus, using prior approaches, creating high-definition maps used for navigation by autonomous vehicles requires expensive and time-consuming on-the-road data collection. In one example, data is collected by a fleet of vehicles equipped with sensors that collect data regarding road conditions. However, due to differences in data collection, precision in the collected data may be poor for certain objects. This creates the technical problem of reducing the accuracy of generated maps and decreasing the reliability of navigation by a vehicle based on such maps. Also, such maps are typically not up-to-date due to the time-consuming data collection required. This can significantly degrade the reliability and/or performance of a vehicle that is navigating using such maps (e.g., navigation in situations for which road conditions have changed due to a recent vehicle accident or natural disaster).

Various embodiments of the present disclosure provide a technological solution to one or more of the above technical problems. In one embodiment, a drone or other UAV can be used to capture a bird's-eye view of a roadway to update an HD map used in guiding autonomous driving. In one example, the updated map is stored on a server and shared with multiple vehicles. In one example, the updated map is stored in memory of a vehicle that is navigating using the map.

In one embodiment, a method includes: storing, in memory, a digital map (e.g., an HD map) used by an autonomous vehicle to plan a navigation route that includes a first geographic location (e.g., a location on a road at which a traffic sign is located); receiving sensor data collected by a sensor of an unmanned aerial vehicle (UAV) at the first geographic location (e.g., image data regarding the traffic sign); processing, by at least one processing device, the received sensor data to generate map data for the first geographic location; and updating, using the generated map data, the digital map (e.g., updating a location and/or type of the traffic sign in the map).

In various embodiments, an autonomous vehicle is capable of sensing its environment and navigating without human input. Examples of autonomous vehicles include self-driving cars. A high-definition map typically refers to maps storing data with high precision (e.g., 5-10 cm or less). High-definition maps contain spatial geometric information about the roads on which an autonomous vehicle will travel.

The generated high-definition maps include information necessary for an autonomous vehicle to navigate safely without human intervention. Instead of collecting data using an expensive and time-consuming mapping fleet process, various embodiments use data collected from unmanned aerial vehicles to generate map data. In one embodiment, the generated map data is used to update a high-definition map used by an autonomous vehicle for navigation.

In one embodiment, an autonomous vehicle navigates using a high-definition map that informs the vehicle regarding objects that are on the road, and/or the condition of the road so that the vehicle can safely navigate without human input. In one example, the map is periodically updated (e.g., every 5-60 minutes, or less) based on data collected by a camera and/or other sensor mounted on a drone. Image data from the camera can be transformed to a format useful for updating the high-definition map. In one example, the transformation is implemented by providing the camera data as an input to a machine-learning model such as an artificial neural network. In one example, the machine-learning model is used to identify features on a road over which the drone is flying, and a car will later follow.

In various embodiments, high-definition maps are generated and maintained that are accurate and include updated road conditions for safe navigation. In one example, the high-definition map provides a current location of an autonomous vehicle relative to the lanes of the road precisely enough to allow the vehicle to drive in the lane.

In one embodiment, an image detection system of a drone, vehicle, and/or map sever receives at least one image from at least one camera mounted on the drone. For example, the image may contain a traffic sign. The image detection system receives the image and identifies the portion of the image corresponding to the traffic sign.

In one embodiment, a machine-learning model is used to classify the traffic sign and assign various attributes to data for the traffic sign. The classification and/or other attributes may be stored in the high-definition map to include a description of the identified traffic sign.

In one embodiment, the drone further includes a light detection and ranging sensor that provides additional data used to generate the map.

In one embodiment, a high-definition map system determines the size of a geographic region represented in the map based on an estimate of an amount of information required to store the objects in the physical area. The estimate is based at least in part on data collected by a drone that flies over the geographic region.

In one embodiment, the generated map includes lane information for streets. The lanes may, for example, include striped lanes, and traffic-direction markings such as arrows painted on a road. A drone that flies over the road is able to collect image data for the stripes, arrows, and other markings on the road. The image data can be used to update a high-definition map used by a vehicle for navigation.

In one embodiment, landmark map data is generated for landmarks in a geographic region. In one example, a deep learning algorithm is used to detect and classify objects based on image data collected by one or more sensors of a drone or other UAV.

In one embodiment, a machine-learning model uses sensor data from one or more drones as inputs along with any contextual/environmental information. This data is transformed into a common data space into which data from any one of the drones can be mapped. In addition, data from sensors on other sources such as the navigating vehicle itself, and/or other autonomous vehicles, and/or other human-powered vehicles can be transformed into the common data space when generating new map data for a digital map. In one example, the machine-learning model uses a neural network.

In one example, contextual information is associated with a sensor such as a camera. In one example, the contextual information relates to the particular sensor used for capturing data. In one example, such information includes a mounting location of the camera in three-dimensional space, an orientation of a camera, a type of camera, a capability or specification of a camera, and a time and date at which data was obtained.

In one embodiment, the machine-learning model uses inputs related to environmental data. In one example, the environmental data includes visibility conditions, lighting measurements, temperature, wind speed, precipitation, and/or other environmental conditions that affect sensor measurements.

In one example, the environmental data includes an altitude and/or speed of the drone that is collecting the data.

In one embodiment, the vehicle is navigating using a digital map. The vehicle determines a mismatch between collected sensor data and data in the digital map regarding a particular object. In response to determining the mismatch, the vehicle requests updated data regarding the object that is collected by one or more unmanned aerial vehicles. In one example, an unmanned aerial vehicle responds in real-time to the request while the vehicle is navigating towards a location at which the object associated with the mismatch is positioned. Based on collected drone data, the vehicle makes a determination of a route for navigation. Further, the collected drone data is used to update the digital map used by the vehicle. In one example, the updated map is stored in memory of the vehicle. In one example, the updated map is uploaded to a server which provides copies of the map to other vehicles.

In one embodiment, collected sensor data from a drone is used for real-time map updates. In one example, the collected sensor data relates to road hazards having a short duration such as a recent vehicle accident, or a natural event such as a fallen tree. In one example, data collected from multiple drones is uploaded into a central database of map information that vehicles download using wireless communication as needed or as requested by any particular vehicle. In one example, maps are updated after events such as floods, earthquakes, tornadoes, etc.

In one example, a server monitors weather data. Based on the weather data, one or more drones are directed to collect sensor data from a region corresponding to a new weather event. The collected sensor data is used to update maps associated with the region.

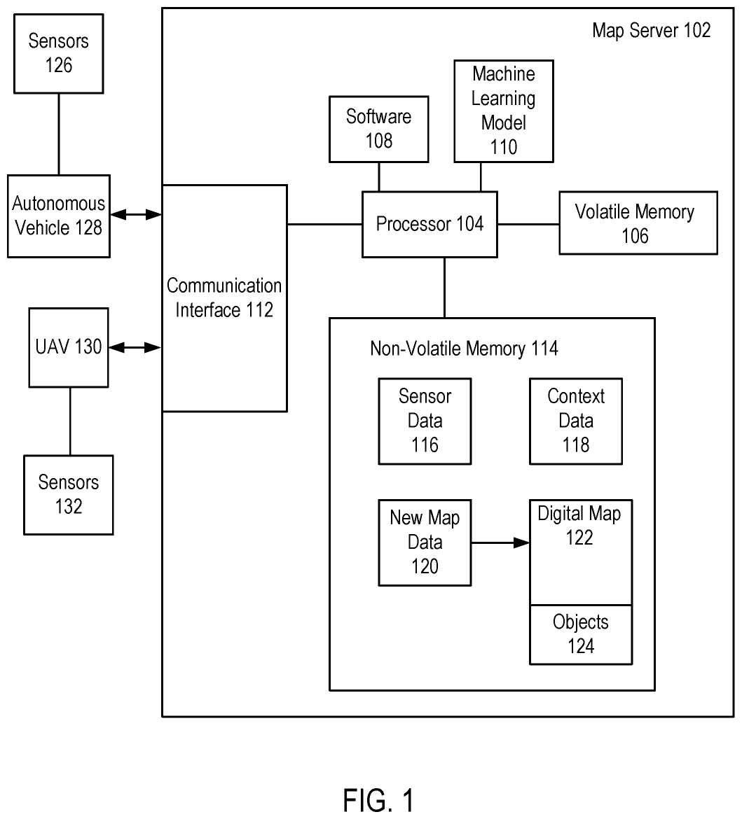

FIG. 1 shows a map server 102 that generates new map data 120 based on sensor data 116 collected by an unmanned aerial vehicle (UAV) 130, in accordance with some embodiments. Sensor data 116 is collected by one or more sensors 132 of UAV 130. UAV 130 communicates the collected sensor data to map server 102 using communication interface 112. In one example, communication interface 112 is implemented using a wireless transceiver. In one example, communication interface 112 is used to implement 5G wireless or satellite communications between map server 102 and UAV 130.

In some embodiments, the sensor data 116 is collected by one or more sensors 126 of autonomous vehicle 128. Sensor data 116 can be collected from UAV 130 and/or autonomous vehicle 128. The collected sensor data is transmitted by autonomous vehicle 128 and received by map server 102 using communication interface 112. In one example, autonomous vehicle 128 communicates with map server 102 using 5G wireless communication.

Map server 102 includes processor 104, which executes instructions stored in software 108 to implement one or more processes associated with collection of sensor data 116 and generation of new map data 120. In one example, sensor data 116 is initially stored in volatile memory 106 when being received from UAV 130 and/or autonomous vehicle 128. In one example, volatile memory 106 provides a cache used to receive sensor data 116 prior to storage in non-volatile memory 114.

In some embodiments, processor 104 implements a machine-learning model 110. In one example, machine-learning model 110 is an artificial neural network. Machine-learning model 110 uses sensor data 116 as an input to generate new map data 120.

In one embodiment, machine-learning model 110 analyzes sensor data 116 to identify features of an environment in which autonomous vehicle 128 operates and/or will operate in the future. In one example, UAV 130 flies to a geographic location of a road on which autonomous vehicle 128 will travel in the future. Sensor data 116 collected by sensors 132 at the geographic location is transmitted to map server 102. Machine-learning model 110 analyzes this collected data to identify features at the geographic location.

In one example, the features include physical objects. In one example, the physical objects include traffic control structures such as signal lights and stop signs. In one example, the physical objects include debris left from prior vehicles traveling on a road and/or vehicle collisions. In one example, the physical objects include debris from natural disasters such as windstorms or tornadoes.

In one example, the features relate to aspects of the road itself. In one example, these aspects are markings on the road such as lane markings, arrows, etc.

In some embodiments, sensor data 116 and context data 118 are stored in non-volatile memory 114. Context data 118 is data that indicates or describes a context in which sensor data 116 is collected. In one example, context data 118 is metadata to sensor data 116 and indicates a particular sensor that collected the data. In one example, context data 118 indicates a type of sensor, a geographic location, a time of day, a specific vehicle or UAV that collected the data, weather or other environmental conditions when the data is collected, etc. In one embodiment, sensor data 116 and context data 118 are used as inputs to machine-learning model 110 when generating new map data 120.

In various embodiments, new map data 120 is used to create and/or update digital map 122. In one example, digital map 122 is a high-definition map used for navigation by a vehicle. In one embodiment, no prior map exists for a given geographic location, and new map data 120 is used to create a new digital map 122. In one embodiment, a prior map exists for a given geographic location, and new map data 120 is used to update a prior digital map 122. In one example, the prior digital map 122 is updated to incorporate objects 124 associated with a recent vehicle collision and/or natural disaster event at the geographic location.

In one embodiment, a new digital map 122 or an updated digital map 122 contains objects 124 that correspond to physical features determined to exist at a geographic location at which sensors 126 and/or 132 have collected data. In one example, objects 124 are traffic control devices. In one example, objects 124 are traffic-control markings on a road, such as painted lane stripes and arrows.

In one embodiment, after being created or updated, digital map 122 is transmitted to autonomous vehicle 128 using communication interface 112. The transmitted digital map 122 is stored in a non-volatile memory of autonomous vehicle 128 and used for navigation and/or driving control.

In some embodiments, digital map 122 can be alternatively and/or additionally transmitted to UAV 130 for storage in its non-volatile memory. UAV 130 can use the transmitted map for navigation and/or flight control.

In one embodiment, UAV 130 collects sensor data at a geographic location (e.g., a predefined region relative to a GPS coordinate on a road) in response to a request received from map server 102 over a communication interface 112. In one example, the request is initiated by autonomous vehicle 128 sending a communication to map server 102. In one example, the request relates to a road on which the autonomous vehicle 128 will navigate in the future. In one example, autonomous vehicle 128 transmits a wireless communication directly to UAV 130 to request sensor data.

In one embodiment, autonomous vehicle 128 detects a new object on a road. Autonomous vehicle 128 determines whether a stored digital map (e.g., a local map and/or a map on a server) includes data associated with the new object. In response to determining that the stored digital map does not include data associated with the new object, autonomous vehicle 128 sends a request (directly or via a server or other computing device) to UAV 130 to collect sensor data regarding the new object.

In one embodiment, digital map 122 includes data for several geographic regions. A memory allocation or storage size in memory for each geographic region is determined based on a geographic size of the region. The geographic size for each geographic region is based at least in part on the sensor data collected by UAV 130 for the respective geographic region.

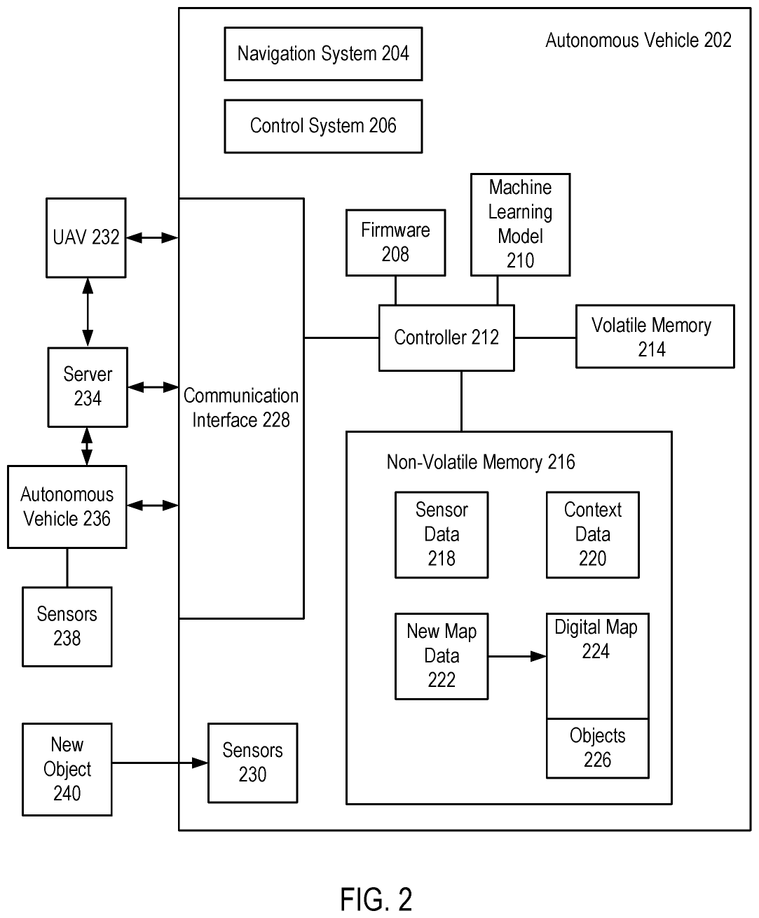

FIG. 2 shows an autonomous vehicle 202 that stores a digital map 224 based in part on data collected by an unmanned aerial vehicle (UAV) 232, in accordance with some embodiments. Autonomous vehicle 202 is an example of autonomous vehicle 128. Digital map 224 is an example of digital map 122. UAV 232 is an example of UAV 130.

Autonomous vehicle 202 navigates using digital map 224, which is stored in non-volatile memory 216. In some embodiments, digital map 224 is received by communication interface 228 from server 234. In one example, server 234 stores digital maps for use by multiple autonomous vehicles. Server 234 is an example of map server 102.

In one embodiment, digital map 224 is updated based on new map data 222. In one example, digital map 224 is updated to include objects 226 (e.g., objects newly-discovered by UAV 232), which are represented by new map data 222.

In one embodiment, new map data 222 is generated using machine-learning model 210. Sensor data 218 and/or context data 220 are used as inputs to machine-learning model 210. Sensor data 218 can be collected by sensors 238 of autonomous vehicle 236 and/or sensors (not shown) of UAV 232.

In addition, in some embodiments, sensor data 218 can further include data collected by one or more sensors 230 (e.g., a radar or LiDAR sensor) of autonomous vehicle 202. In one example, sensors 230 collect data regarding a new object 240 that is in the environment of autonomous vehicle 202. In one example, new object 240 is a traffic sign detected by a camera of autonomous vehicle 202.

In some embodiments, data collected by autonomous vehicle 236 and/or UAV 232 is wirelessly transmitted to server 234. The collected data is used to generate and/or update one or more maps stored on server 234. The generated and/or updated maps are wirelessly communicated to autonomous vehicle 202 and stored as digital map 224. In one example, context data 220 is collected by autonomous vehicle 236 and/or UAV 232 when sensor data 218 is collected. The context data 220 is transmitted by server 234 to autonomous vehicle 202.

In other embodiments, sensor data can be transmitted directly from autonomous vehicle 236 and/or UAV 232 to autonomous vehicle 202. In one example, autonomous vehicle 236 is traveling a distance (e.g., 1-10 km, or less) ahead of autonomous vehicle 202 on the same road and transmits data regarding object 226 that is detected by autonomous vehicle 236. In one example, UAV 232 is flying ahead (e.g., 5-100 km, or less) of autonomous vehicle 202 on the same road and transmits sensor data regarding the road, features of the road, and/or other environmental aspects associated with navigation on the road, as collected by sensors of UAV 232.

Autonomous vehicle 202 includes a controller 212 that executes instructions stored in firmware 208 to implement one or more processes regarding sensor data collection and/or map generation as described herein. Controller 212 stores incoming sensor data in volatile memory 214 prior to copying the sensor data to non-volatile memory 216.

Controller 212 controls the operation of a navigation system 204 and a control system 206. Navigation system 204 uses digital map 224 to plan a route for navigating the autonomous vehicle 202. Control system 206 uses digital map 224 to control steering, speed, braking, etc. of autonomous vehicle 202. In one example, control system 206 uses data collected by sensors 230 along with data from digital map 224 when controlling autonomous vehicle 202.

In one embodiment, new object 240 is detected by sensors 230 (and/or other sensors described herein). Machine-learning model 210 is used to classify new object 240. A determination is made whether new object 240 corresponds to one of objects 226. In response to determining that new object 240 does not exist in digital map 224, new map data 222 is used to update digital map 224. New map data 222 includes data associated with new object 240, including the determined classification and a geographic location.

In one embodiment, autonomous vehicle 202 determines that new object 240 is not included in digital map 224. In response to this determination, autonomous vehicle 202 sends a request to server 234 to obtain new map data 222 for updating digital map 224.

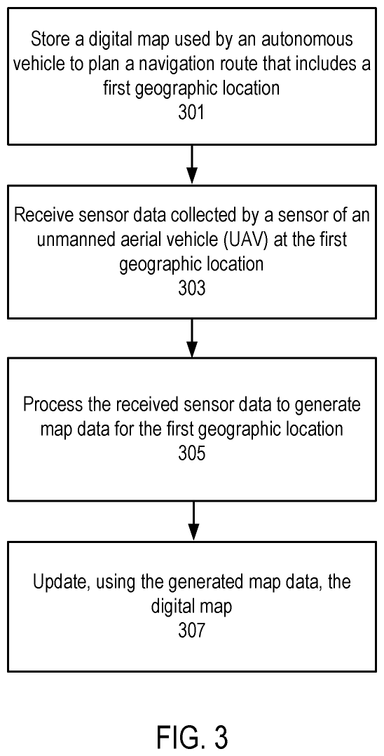

FIG. 3 shows a method for updating a digital map based on sensor data collected by an unmanned aerial vehicle, in accordance with some embodiments. For example, the method of FIG. 3 can be implemented in the system of FIG. 1 or 2. In one example, the digital map is digital map 122 or 224. In one example, the unmanned aerial vehicle is UAV 130 or 232.

The method of FIG. 3 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method of FIG. 3 is performed at least in part by one or more processing devices (e.g., processor 104 of FIG. 1 or controller 212 of FIG. 2).

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 301, a digital map is stored for use by an autonomous vehicle. The vehicle uses the stored digital map to plan a navigation route that includes a first geographic location. In one example, digital map 122 is stored in non-volatile memory 114 and transmitted to autonomous vehicle 128 for use in navigation. In one example, digital map 224 is stored in non-volatile memory 216 of autonomous vehicle 202. Navigation system 204 uses digital map 224 to plan a navigation route.

At block 303, sensor data is received that has been collected by one or more sensors of an unmanned aerial vehicle at the first geographic location. In one example, map server 102 receives sensor data 116 from UAV 130. The UAV 130 is flying over the first geographic location when the sensor data 106 is collected. In one example, autonomous vehicle 202 receives sensor data 218 from UAV 232.

At block 305, the received sensor data is processed to generate map data for the first geographic location (e.g., to generate new data regarding objects at the location). In one example, sensor data 116 is processed using machine-learning model 110 to generate new map data 120. In one example, sensor data 218 is processed using machine-learning model 210 to generate new map data 222.

At block 307, the digital map is updated using the generated map data. In one example, digital map 122 is updated using new map data 120. In one example, digital map 224 is updated using new map data 222.

In one embodiment, a method comprises: storing, in memory (e.g., non-volatile memory 114), a digital map used by an autonomous vehicle (e.g., autonomous vehicle 128 or 202) to plan a navigation route that includes a first geographic location (e.g., a position on a road, or a pre-defined shape of region and/or a predetermined size of a region relative to a location on a road (e.g., relative to a location at specific GPS coordinates)); receiving sensor data collected by a sensor of an unmanned aerial vehicle (e.g., UAV 130 or 232) at the first geographic location; processing, by at least one processing device, the received sensor data to generate map data for the first geographic location; and updating, using the generated map data, the digital map (e.g., digital map 122 or 224).

In one embodiment, the digital map is a high-definition (HD) map.

In one embodiment, the received sensor data is processed using a machine-learning model (e.g., machine-learning model 110 or 210).

In one embodiment, an output of the machine-learning model provides a classification for an object associated with the sensor data, and updating the digital map comprises adding the object (e.g., object 124 or 226) and the classification to the digital map.

In one embodiment, the method further comprises transmitting, to the autonomous vehicle, the updated digital map.

In one embodiment, the method further comprises sending a request to the UAV, wherein the sensor data is collected by the UAV in response to the request.

In one embodiment, the method further comprises receiving a request from the autonomous vehicle, wherein the request to the UAV is sent in response to receiving the request from the autonomous vehicle.

In one embodiment, the method further comprises: detecting a new object (e.g., new object 240); and determining whether the stored digital map includes data associated with the new object; wherein the request to the UAV is sent in response to determining that the stored digital map does not include data associated with the new object.

In one embodiment, the new object is detected by at least one of the autonomous vehicle or the UAV.

In one embodiment, the received sensor data is first sensor data, the generated map data is first map data, the digital map is updated to include an object detected at the first geographic location, and the autonomous vehicle is a first autonomous vehicle (e.g., autonomous vehicle 202). The method further comprises: receiving second sensor data collected by a sensor of a second autonomous vehicle (e.g., autonomous vehicle 236) at the first geographic location; determining that the second sensor data is associated with the object; processing the second sensor data to generate second map data; and updating the digital map using the second map data.

In one embodiment, the sensor (e.g., at least one of sensors 126, 132, 230, 238) is a light detection and ranging (LiDAR) sensor, a radar sensor, or a camera.

In one embodiment, the stored digital map includes respective data for each of a plurality of geographic regions. The method further comprises determining a geographic size for each geographic region based at least in part on respective sensor data collected by the UAV for each geographic region.

In one embodiment, the method further comprises: determining, using the received sensor data, at least one marking on a road at the first geographic location; wherein the generated map data includes the at least one marking.

In one embodiment, the method further comprises controlling a steering system of the autonomous vehicle using the updated digital map. In one example, control system 206 controls a steering system of autonomous vehicle 202.

In one embodiment, the sensor data is received by the autonomous vehicle.

In one embodiment, a system comprises: at least one memory device configured to store a digital map used by an autonomous vehicle to plan a navigation route that includes a geographic location; at least one processing device; and memory containing instructions configured to instruct the at least one processing device to: receive sensor data collected by a sensor of an unmanned aerial vehicle (UAV) at the geographic location; process the received sensor data to generate map data for the geographic location; and update, using the generated map data, the stored digital map.

In one embodiment, processing the received sensor data comprises providing the sensor data as an input to a machine-learning model that provides an output used to identify an object at the geographic location; and updating the stored digital map comprises adding the identified object to the digital map.

In one embodiment, the instructions are further configured to instruct the at least one processing device to: determine whether the identified object exists in the stored digital map; wherein updating the stored digital map is performed in response to determining that the identified object does not exist in the digital map.

In one embodiment, a non-transitory computer-readable medium stores instructions which, when executed on a computing device of an autonomous vehicle, cause the computing device to at least: store, in memory, a digital map used by the autonomous vehicle to plan a navigation route that includes a geographic location; receive new data collected by a sensor of an unmanned aerial vehicle (UAV) at the geographic location; process the new data to generate map data for the geographic location; and update, using the generated map data, the digital map.

In one embodiment, the instructions further cause the computing device to: collect data from at least one sensor of the autonomous vehicle that identifies an object at the geographic location; determine that existing data stored in the digital map for the object does not correspond to the collected data; and in response to determining that the data stored in the digital map for the object does not correspond to the collected data, send a request to a server for the new data; wherein the new data is received by the autonomous vehicle from the server in response to the request for the new data.

The disclosure includes various devices which perform the methods and implement the systems described above, including data processing systems which perform these methods, and computer-readable media containing instructions which when executed on data processing systems cause the systems to perform these methods.

The description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In this description, various functions and operations may be described as being performed by or caused by software code to simplify description. However, those skilled in the art will recognize what is meant by such expressions is that the functions result from execution of the code by one or more processors, such as a microprocessor, Application-Specific Integrated Circuit (ASIC), graphics processor, and/or a Field-Programmable Gate Array (FPGA). Alternatively, or in combination, the functions and operations can be implemented using special purpose circuitry (e.g., logic circuitry), with or without software instructions. Embodiments can be implemented using hardwired circuitry without software instructions, or in combination with software instructions. Thus, the techniques are not limited to any specific combination of hardware circuitry and software, nor to any particular source for the instructions executed by a computing device.

While some embodiments can be implemented in fully functioning computers and computer systems, various embodiments are capable of being distributed as a computing product in a variety of forms and are capable of being applied regardless of the particular type of computer-readable medium used to actually effect the distribution.

At least some aspects disclosed can be embodied, at least in part, in software. That is, the techniques may be carried out in a computing device or other system in response to its processing device, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions (sometimes referred to as computer programs). Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A computer-readable medium can be used to store software and data which when executed by a computing device causes the device to perform various methods. The executable software and data may be stored in various places including, for example, ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a computer-readable medium in entirety at a particular instance of time.

Examples of computer-readable media include but are not limited to recordable and non-recordable type media such as volatile and non-volatile memory devices, read only memory (ROM), random access memory (RAM), flash memory devices, solid-state drive storage media, removable disks, magnetic disk storage media, optical storage media (e.g., Compact Disk Read-Only Memory (CD ROMs), Digital Versatile Disks (DVDs), etc.), among others. The computer-readable media may store the instructions.

In general, a non-transitory computer-readable medium includes any mechanism that provides (e.g., stores) information in a form accessible by a computing device (e.g., a computer, mobile device, network device, personal digital assistant, manufacturing tool having a controller, any device with a set of one or more processors, etc.).

In various embodiments, hardwired circuitry may be used in combination with software and firmware instructions to implement the techniques. Thus, the techniques are neither limited to any specific combination of hardware circuitry and software nor to any particular source for the instructions executed by a computing device.

Various embodiments set forth herein can be implemented using a wide variety of different types of computing devices. As used herein, examples of a “computing device” include, but are not limited to, a server, a centralized computing platform, a system of multiple computing processors and/or components, a mobile device, a user terminal, a vehicle, a personal communications device, a wearable digital device, an electronic kiosk, a general purpose computer, an electronic document reader, a tablet, a laptop computer, a smartphone, a digital camera, a residential domestic appliance, a television, or a digital music player. Additional examples of computing devices include devices that are part of what is called “the internet of things” (IOT). Such “things” may have occasional interactions with their owners or administrators, who may monitor the things or modify settings on these things. In some cases, such owners or administrators play the role of users with respect to the “thing” devices. In some examples, the primary mobile device (e.g., an Apple iPhone) of a user may be an administrator server with respect to a paired “thing” device that is worn by the user (e.g., an Apple watch).

In some embodiments, the computing device can be a computer or host system, which is implemented, for example, as a desktop computer, laptop computer, network server, mobile device, or other computing device that includes a memory and a processing device. The host system can include or be coupled to a memory sub-system so that the host system can read data from or write data to the memory sub-system. The host system can be coupled to the memory sub-system via a physical host interface. In general, the host system can access multiple memory sub-systems via a same communication connection, multiple separate communication connections, and/or a combination of communication connections.

In some embodiments, the computing device is a system including one or more processing devices. Examples of the processing device can include a microcontroller, a central processing unit (CPU), special purpose logic circuitry (e.g., a field programmable gate array (FPGA), an application specific integrated circuit (ASIC), etc.), a system on a chip (SoC), or another suitable processor.

In one example, a computing device is a controller of a memory system. The controller includes a processing device and memory containing instructions executed by the processing device to control various operations of the memory system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method comprising:
storing, in memory, a digital map used by an autonomous vehicle to plan a navigation route that includes a first geographic location;
receiving, in real-time by the vehicle from an unmanned aerial vehicle (UAV), sensor data collected by a sensor of the UAV at the first geographic location;
processing, by at least one processing device, the received sensor data to generate map data for the first geographic location; and
updating, using the generated map data, the digital map.

2. The method of claim 1, wherein the sensor data is first sensor data, the method further comprising:
collecting, by the vehicle, second sensor data regarding an object located at the first geographic location;
determining, by the vehicle, a mismatch between the second sensor data and data regarding the object in the digital map;
in response to determining the mismatch, sending a request to the UAV for updated data regarding the object, wherein the UAV responds in real-time to the request while the vehicle is navigating towards the first geographic location, and wherein the first sensor data is received by the vehicle from the UAV in response to the request; and
determining, based on the received first sensor data, the navigation route.

3. The method of claim 1, wherein the received sensor data is processed using a machine-learning model.

4. The method of claim 3, wherein an output of the machine-learning model provides a classification for an object associated with the sensor data, and updating the digital map comprises adding the object and the classification to the digital map.

5. The method of claim 1, further comprising transmitting, to the autonomous vehicle, the updated digital map.

6. The method of claim 1, further comprising sending a request to the UAV, wherein the sensor data is collected by the UAV in response to the request.

7. The method of claim 6, further comprising receiving a request from the autonomous vehicle, wherein the request to the UAV is sent in response to receiving the request from the autonomous vehicle.

8. The method of claim 6, further comprising:
detecting a new object; and
determining whether the stored digital map includes data associated with the new object;
wherein the request to the UAV is sent in response to determining that the stored digital map does not include data associated with the new object.

9. The method of claim 8, wherein the new object is detected by at least one of the autonomous vehicle or the UAV.

10. The method of claim 1, wherein the received sensor data is first sensor data, the generated map data is first map data, the digital map is updated to include an object detected at the first geographic location, and the autonomous vehicle is a first autonomous vehicle, the method further comprising:
receiving second sensor data collected by a sensor of a second autonomous vehicle at the first geographic location;
determining that the second sensor data is associated with the object;
processing the second sensor data to generate second map data; and
updating the digital map using the second map data.

11. The method of claim 1, wherein the sensor is a light detection and ranging (LiDAR) sensor, a radar sensor, or a camera.

12. The method of claim 1, wherein the stored digital map includes respective data for each of a plurality of geographic regions, the method further comprising determining a geographic size for each geographic region based at least in part on respective sensor data collected by the UAV for each geographic region.

13. The method of claim 1, further comprising:
determining, using the received sensor data, at least one marking on a road at the first geographic location;
wherein the generated map data includes the at least one marking.

14. The method of claim 1, further comprising controlling a steering system of the autonomous vehicle using the updated digital map.

15. The method of claim 1, wherein the sensor data is received by the autonomous vehicle directly from the UAV without being communicated through an intervening electronic device.

16. A system comprising:
at least one memory device configured to store a digital map used by an autonomous vehicle to plan a navigation route that includes a geographic location;
at least one processing device; and
memory containing instructions configured to instruct the at least one processing device to:
receive sensor data collected by a sensor of an unmanned aerial vehicle (UAV) at the geographic location, wherein the sensor data is received by the autonomous vehicle directly from the UAV without being communicated through an intervening electronic device;
process the received sensor data to generate map data for the geographic location; and
update, using the generated map data, the stored digital map.

17. The system of claim 16, wherein:
processing the received sensor data comprises providing the sensor data as an input to a machine-learning model that provides an output used to identify an object at the geographic location; and
updating the stored digital map comprises adding the identified object to the digital map.

18. The system of claim 17, wherein the instructions are further configured to instruct the at least one processing device to:
determine whether the identified object exists in the stored digital map;
wherein updating the stored digital map is performed in response to determining that the identified object does not exist in the digital map.

19. A non-transitory computer-readable medium storing instructions which, when executed on a computing device of an autonomous vehicle, cause the computing device to at least:
store, in memory, a digital map used by the autonomous vehicle to plan a navigation route that includes a geographic location;
receive new data collected by a sensor of an unmanned aerial vehicle (UAV) at the geographic location, wherein the sensor data is received by the autonomous vehicle directly from the UAV without being communicated through an intervening electronic device;
process the new data to generate map data for the geographic location; and
update, using the generated map data, the digital map.

20. The non-transitory computer-readable medium of claim 19, wherein the instructions further cause the computing device to:
collect data from at least one sensor of the autonomous vehicle that identifies an object at the geographic location;
determine that existing data stored in the digital map for the object does not correspond to the collected data; and
in response to determining that the data stored in the digital map for the object does not correspond to the collected data, send a request to a server for the new data;
wherein the new data is received by the autonomous vehicle from the server in response to the request for the new data.
